(19) United States
(12) Patent Application Publication
(10) Pub. No.: US 2013/0173431 A1
(43) Pub. Date: Jul. 4, 2013

(54) PRODUCT COMPARISON

(71) Applicants: Gregory M. Nations, Minneapolis, MN (US); Chad R. Gourley, Elk River, MN (US); Michael F. Gonsalves, Minneapolis, MN (US); Sarah E. Schoeffler, Minneapolis, MN (US)

(72) Inventors: Gregory M. Nations, Minneapolis, MN (US); Chad R. Gourley, Elk River, MN (US); Michael F. Gonsalves, Minneapolis, MN (US); Sarah E. Schoeffler, Minneapolis, MN (US)

(73) Assignee: TARGET BRANDS, INC., Minneapolis, MN (US)

(21) Appl. No.: 13/339,176

(22) Filed: Dec. 28, 2011

(51) Int. Cl. G06Q 30/00

(52) U.S. Cl. 705/26.64

(57) ABSTRACT

Products that have been marked on a display as being selected for comparison with each other are counted. In response to the count being equal to or greater than a trigger number of products, a display is altered to add at least one compare link to the display. The compare link is such that when the user selects the compare link, the display shows a comparison of the products that have been marked on the display.

### BACKGROUND

Retail websites display products that are available for purchase. On some sites, it is possible to select two or more products for comparison. Often, this is done by selecting respective “compare” checkboxes associated with the products and then activating a “compare” button or link. Activating the compare button or link downloads a page that displays a table in which various attributes of the selected products are compared to each other.

Often, the customer viewing the website must scroll down through the page to view all of the products. During this scrolling, the “compare” button or link will scroll out of view.

The discussion above is merely provided for general background information and is not intended to be used as an aid in determining the scope of the claimed subject matter. The claimed subject matter is not limited to implementations that solve any or all disadvantages noted in the background.

### SUMMARY

Products that have been marked on a display as being selected for comparison with each other are counted. In response to the count being equal to a trigger number of products that can be compared with each other, a display is altered to add at least one compare link to the display. The compare link is such that when the user selects the compare link, the display shows a comparison of the products that have been marked on the display.

In other embodiments, a memory stores a count of the number of items that are marked on a display as having been selected by a user for comparison. A processor retrieves the count from the memory and determines that the count is equal to the trigger number of items that can be compared. The processor displays a dialog box comprising a link to a compare page in response to the count being equal to the trigger number of items that can be compared.

In a further embodiment, a collection of items is displayed on a display. An input from a user is received that indicates that an item in the collection of items should be marked for comparison. In response to the input, an element comprising a link to a comparison page is displayed such that the element at least partially covers at least one of the items in the collection of items.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an example of a screenshot of a retail web page displaying items according to one embodiment.

FIG. 2 is an example of a second screenshot of a retail web page displaying items according to one embodiment.

FIG. 3 is a flow diagram of a method invoked when a user clicks on a compare checkbox according to one embodiment.

FIG. 4 is an example, according to one embodiment, of a screenshot of an element displayed over a retail web page when a user has selected the trigger number of products to be compared.

FIG. 5 is an example, according to one embodiment, of a screenshot of the retail web page after the user has closed the element of FIG. 4.

FIG. 6 is an example, according to one embodiment, of a screenshot of an element displayed over the retail web page of FIG. 5 when a user attempts to select more than a maximum number of products that can be compared.

FIG. 7 is an example, according to one embodiment, of a comparison page showing a comparison of items marked in FIG. 6.

FIG. 8 is a block diagram of a computer network according to one embodiment.

FIG. 9 is a block diagram of a computing device according to one embodiment.

### DETAILED DESCRIPTION

Innovations described below automatically generate a graphical element when a user selects a trigger number of items to compare. The graphical element includes a compare button that when selected retrieves a comparison page that shows a comparison of the selected items.

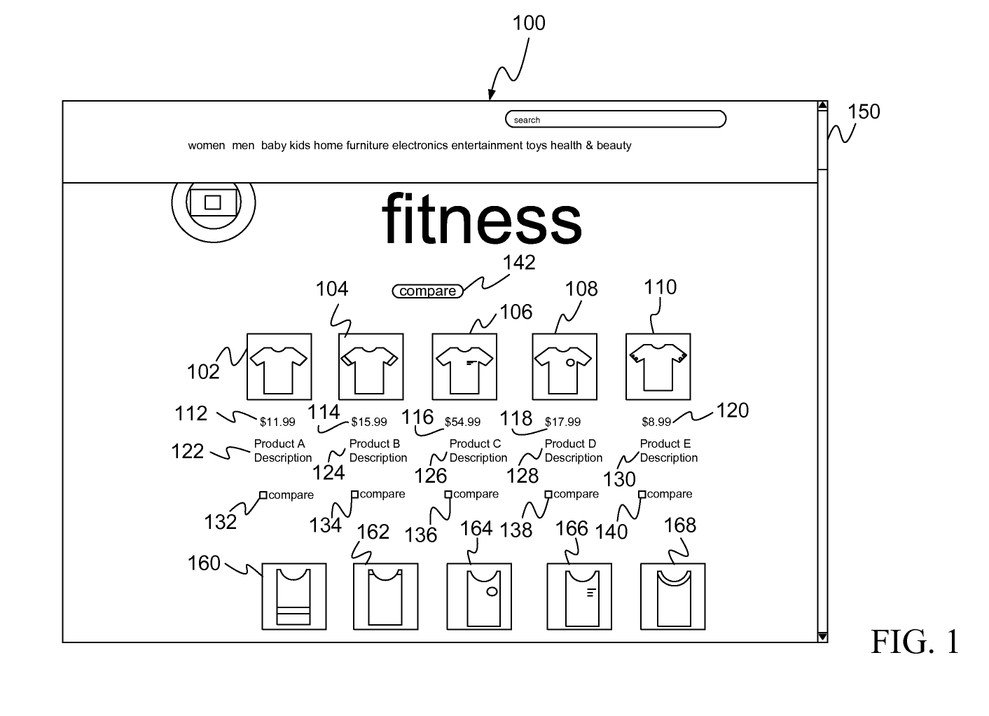

FIG. 1 provides an example of a generated computer image 100. Generated image 100 may be generated by any of a number of different computing devices including a desktop computer, a laptop computer, a tablet computer, a handheld device, a mobile phone, a gaming device, an entertainment device, or any other computing device that can connect to a network and download a network page that defines the generated image 100 of FIG. 1.

Generated image 100 provides a webpage showing images of a collection of products including product image 102, product image 104, product image 106, product image 108, product image 110, product image 160, product image 162, product image 164, product image 166, and product image 168.

Each of product images 102, 104, 106, 108 and 110 has a respective price 112, 114, 116, 118, and 120. Each of product images 102, 104, 106, 108 and 110 also has a respective product description 122, 124, 126, 128, and 130. Product descriptions 122, 124, 126, 128 and 130 can include the name of the product and a short description of one or more attributes of the product.

In accordance with some embodiments, product images 102, 104, 106, 108, 110, 160, 162, 164, 166, and 168 are selectable by highlighting the product image and pressing enter, tapping on the product image or by positioning a cursor over the product image and activating a selection button. In accordance with some embodiments, product descriptions 122, 124, 126, 128 and 130 may be selectable in a similar fashion.

Each of product images 102, 104, 106, 108 and 110 has a respective selectable compare box 132, 134, 136, 138 and 140. Each of compare boxes 132, 134, 136, 138 and 140 has two states; an unchecked state as shown in FIG. 1 and a checked state in which a check mark is displayed within or over the compare check box. To change the state of a compare check box, a user selects the compare check box by highlighting the compare check box and pressing enter, touching the compare check box through a touch screen or positioning a cursor over the compare check box and pressing a selection button. Although a compare check box can always be changed from a checked state to an unchecked state, in some embodiments, compare check boxes are prevented from changing to a checked state if a maximum number of compare check boxes have already been placed in the checked state.

Generated image 100 also includes a compare button/link 142. In accordance with some embodiments, if the user selects the compare button/link 142 after having selected one or more of the compare check boxes 132, 134, 136, 138 and 140, a comparison page will be displayed that shows a comparison of several attributes of the products that have their compare check box selected.

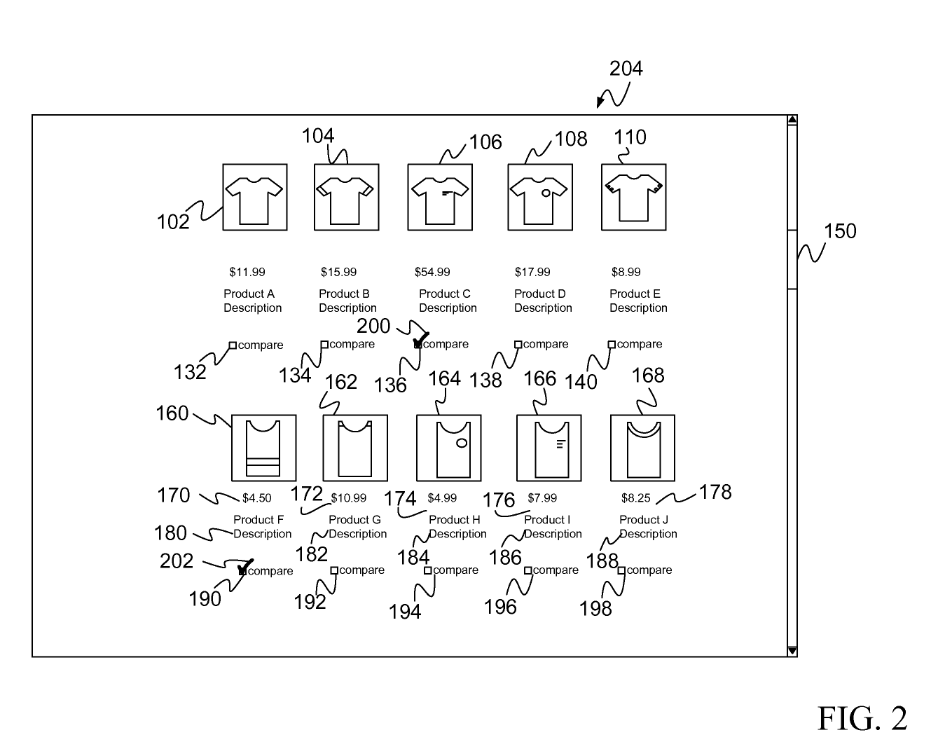

Generated image 100 also includes a scroll bar 150 that allows a user to scroll down through the generated image 100. FIG. 2, provides a view of the generated image after scroll bar 150 has been moved downward to expose prices 170, 172, 174, 176 and 178 of respective product images 160, 162, 164, 166 and 168. In addition, product descriptions 180, 182, 184, 186 and 188 and compare check boxes 190, 192, 194, 196 and 198 of product images 160, 162, 164, 166 and 168 have been exposed. Note that by moving scroll bar 150 downward, compare button 142 has been removed from view.

As shown in FIG. 2, compare check boxes 136 and 190 have been selected by the user after scrolling down and check marks 200 and 202 have been placed in compare check boxes 136 and 190, respectively.

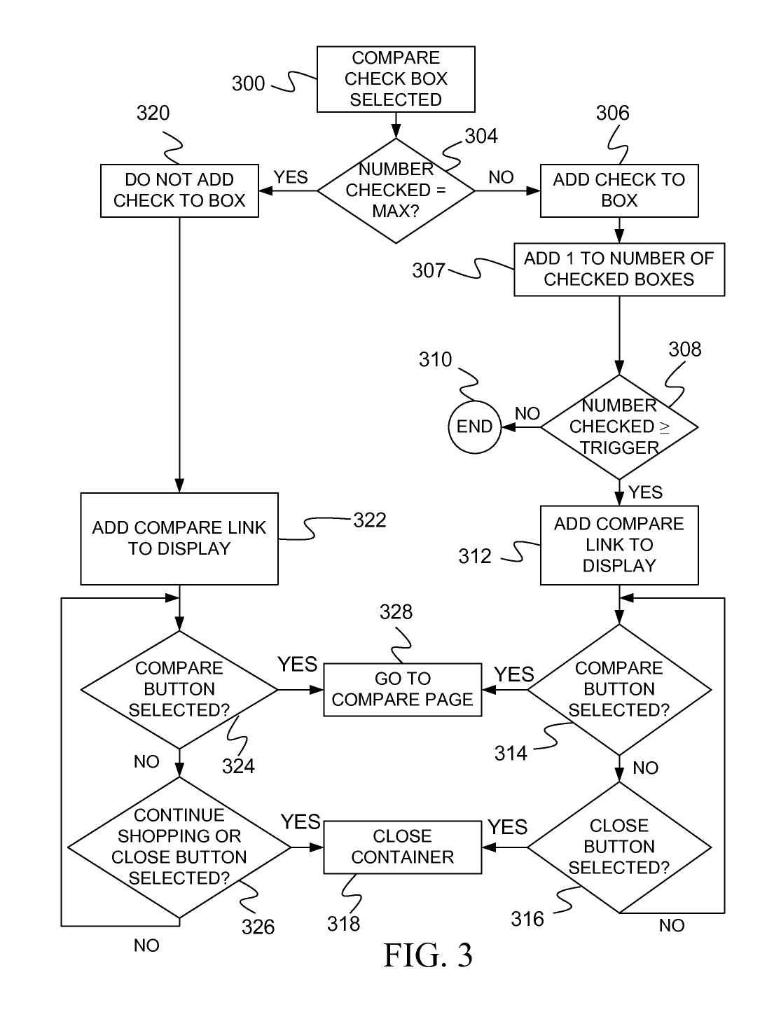

FIG. 3 provides a flow diagram of a method that is invoked when a user selects a compare check box such as compare check boxes 136 and 190. At step 300 of the method, a compare check box is selected. At step 304, the number of compare check boxes that are currently checked is compared to a maximum number of products that can be compared on a comparison page. For example, under some embodiments, the maximum number of products that can be compared on the comparison page is three. As such, the number of currently checked boxes is compared to the number three in such embodiments. The compare check boxes that are currently checked are those check boxes that currently have a check mark in them. The compare check box that is selected in step 300 is not counted as a compare check box that is currently checked until a check mark has been added to the box.

If the number of checked boxes does not equal the maximum number of products that can be compared on the comparison page, a check mark is added to the selected compare check box at step 306. For example, check mark 200 was added to compare check box 136 in FIG. 2 at step 306. The number of currently checked boxes is then increased by one at step 307 and the number of currently checked boxes is stored in memory.

At step 308, the new number of currently checked boxes is compared to a trigger number of products. The trigger number is a number that will trigger the present system to add a compare link to a current display. For example, the trigger number is two in some embodiments such that if two products have been marked for comparison at step 308, the system will determine that the number of checked products equals or exceeds the trigger number of products. The trigger number may be equal to or less than the maximum number of products that can be checked for comparison.

If the number of currently checked boxes does not equal or exceed the trigger number of products that can be compared on the comparison page at step 308, the process of FIG. 3 ends at step 310.

When the number of check boxes equals or exceeds the trigger number of products that can be compared on the comparison page at step 308, the display is altered to add at least one compare link to the display at step 312. The compare link is such that when the user selects the compare link, the display shows a comparison of the products that have been marked on the display. The compare link may be shown as text, an image of a compare button or some other image. In some embodiments, the compare link is displayed within a container or element that is opened over the displayed images of selectable items/products. Examples of such containers include message boxes, dialog boxes and windows. Under many embodiments, the compare link is added such that it at least partially covers at least one selectable item on a web page. The compare link added at step 312 is added without scrolling the image on the display.

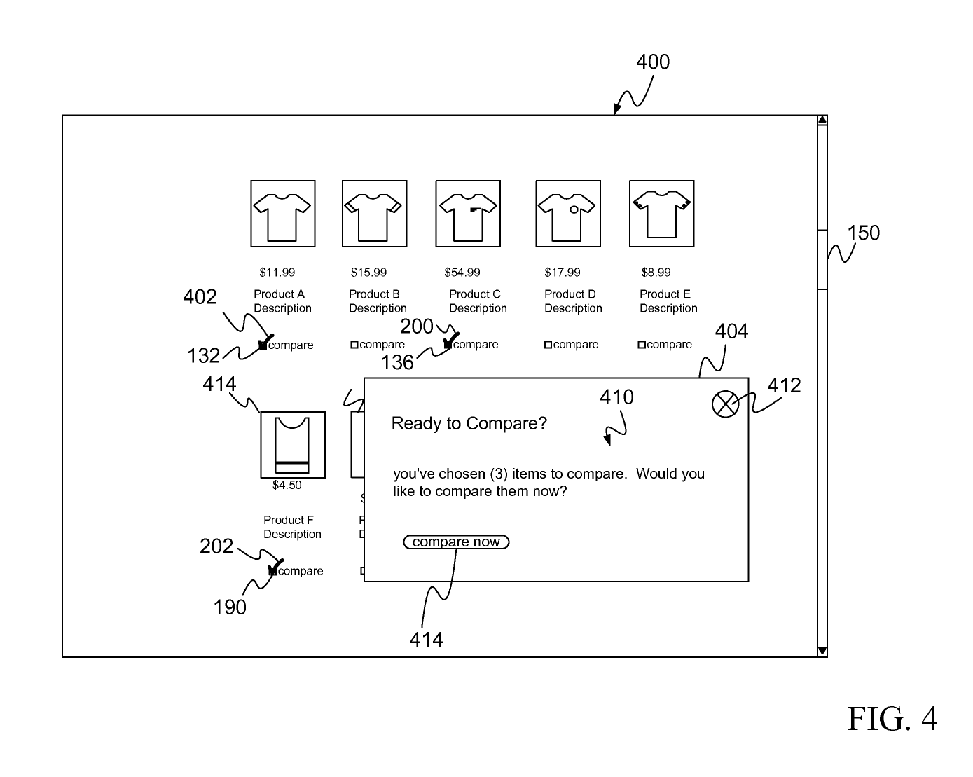

FIG. 4 provides a view of a generated image 400 showing a container 404 displayed over the image of FIG. 2 after a user has selected compare check box 132 at step 300, a check mark 402 has been added to compare check box 132 at step 306, and it has been determined at step 308 that the number of currently checked boxes (three) is equal to the trigger number of products that can be compared. Generated image 400 includes the image elements of generated image 204 with container 404 positioned over some of the image elements of generated image 204. In FIG. 4, compare check boxes 132, 136 and 190 have been checked as indicated by check marks 202, 200 and 402.

Container 404, also referred to as dialog box 404, includes text 410, a close button/close icon 412 and “compare now” button 414. Close button 412 and “compare now” button 414 may be selected by highlighting them using a tab key and pressing a selection button, placing a cursor over them and pressing a selection button or by pressing on them through a touch screen. Text 410 explains that the trigger number of items have been selected for comparison and directs the user to compare the currently selected products.

After dialog box 404 has been opened at step 312, the method of FIG. 3 waits for “compare now” button 414 to be selected at step 314 or close button 412 to be selected at step 316. Note that although steps 314 and 316 are shown as occurring at different times, in event driven systems, these steps occur at the same time.

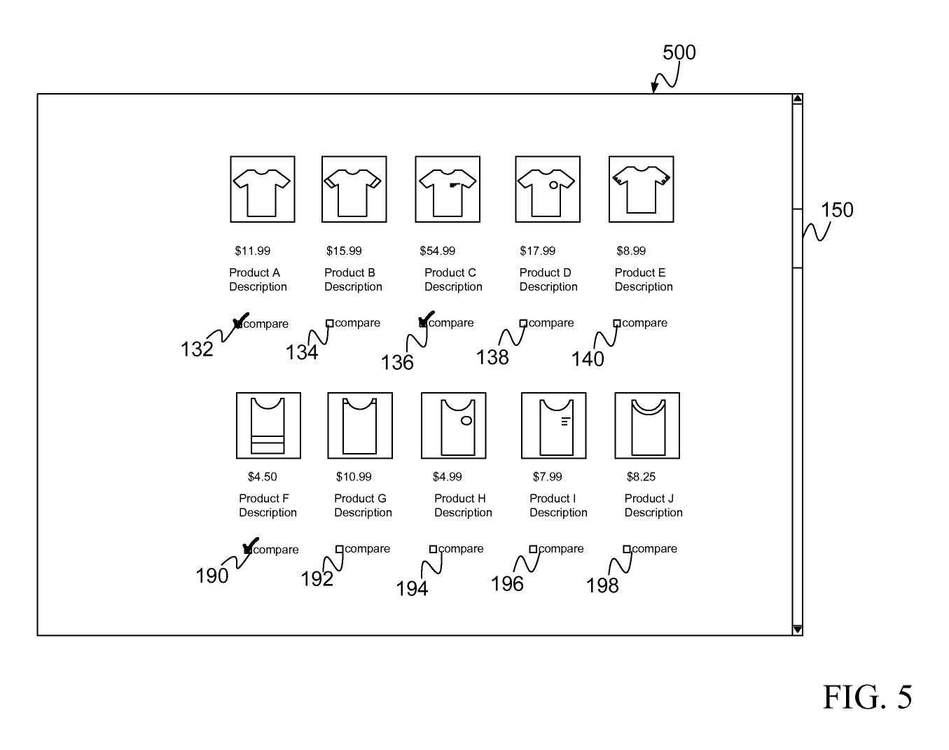

If close button 412 is selected at step 316, dialog box 404 is closed at step 318 and the compare link is removed from the display without showing a comparison of products. FIG. 5 shows a generated image 500 after dialog box 404 has been closed. Note that compare check boxes 132, 136 and 190 continue to be checked.

If the user selects one of the unchecked compare boxes 134, 138, 140, 192, 194, 196, 198 of FIG. 5, the process of FIG. 3 begins again at step 300. The number of checked compare boxes is then compared to the maximum number of products that can be compared on the comparison page at step 304. In embodiments where only three products can be compared, the number of checked compare boxes in FIG. 5 equals the maximum number of products that can be compared at step 304. As a result, the process of FIG. 3 continues at step 320 where a check mark is not added to the selected check box. As a result, in the example of FIG. 5, even though the user selects one of the compare check boxes 134, 138, 140, 192, 194, 196 or 198, a check mark does not appear in the selected check box.

After not adding a mark to the check box, a compare link is added to the display at step 322 without requiring scrolling of the displayed web page. Under some embodiments, the compare link is displayed within a container or element, such as a dialog box, message box or window. In some embodiments, the compare link is added to the display such that it at least partially covers at least one selectable item on the display.

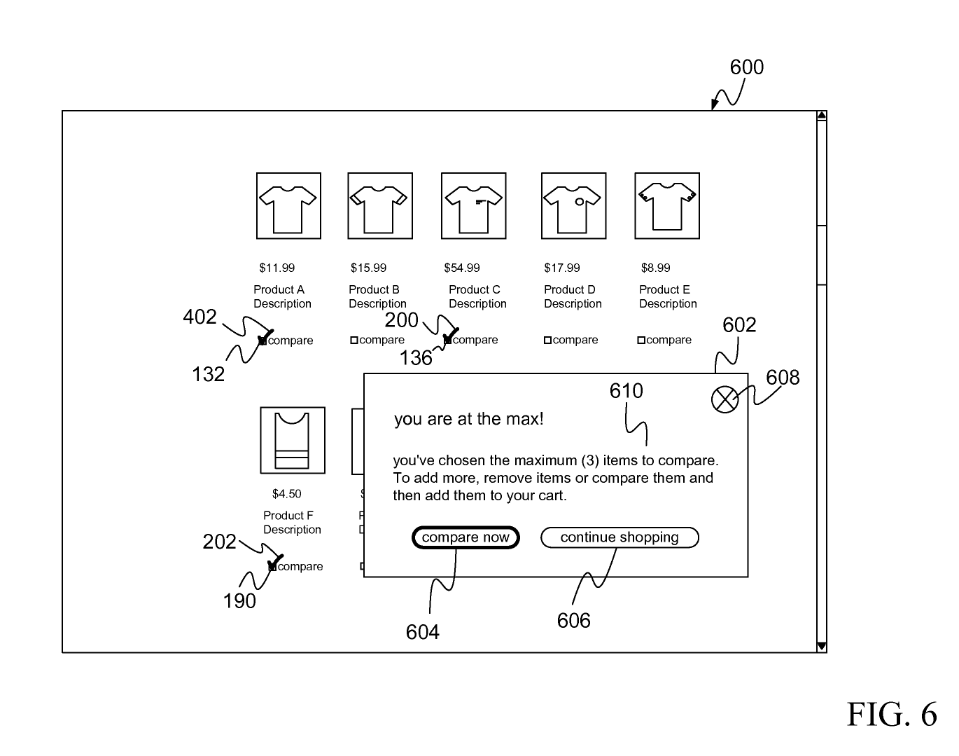

FIG. 6 provides an example of a generated image 600 in which a dialog box 602 has been opened that contains a “compare now” button 604, a “continue shopping” button 606, a close button 608, and text 610. Text 610 indicates that the user has selected the maximum number of items that can be compared and instructs the user that if they wish to add more items, they must deselect some of the items they've already selected to compare or compare the selected items and add one or more of them to their cart.

After dialog box 602 has been opened at step 322, the process of FIG. 3 waits for “compare now” button 604 to be selected at step 324 or for “continue shopping” button 606 or close button 608 to be selected at step 326. Note that although steps 324 and 326 are shown as occurring at different times, in event-driven systems, the steps of waiting for these buttons to be pressed occur at the same time.

If “continue shopping” button 606 or close button 608 are selected at step 326, dialog box 602 is closed at step 318 and the appearance of the generated image returns to that shown in FIG. 5.

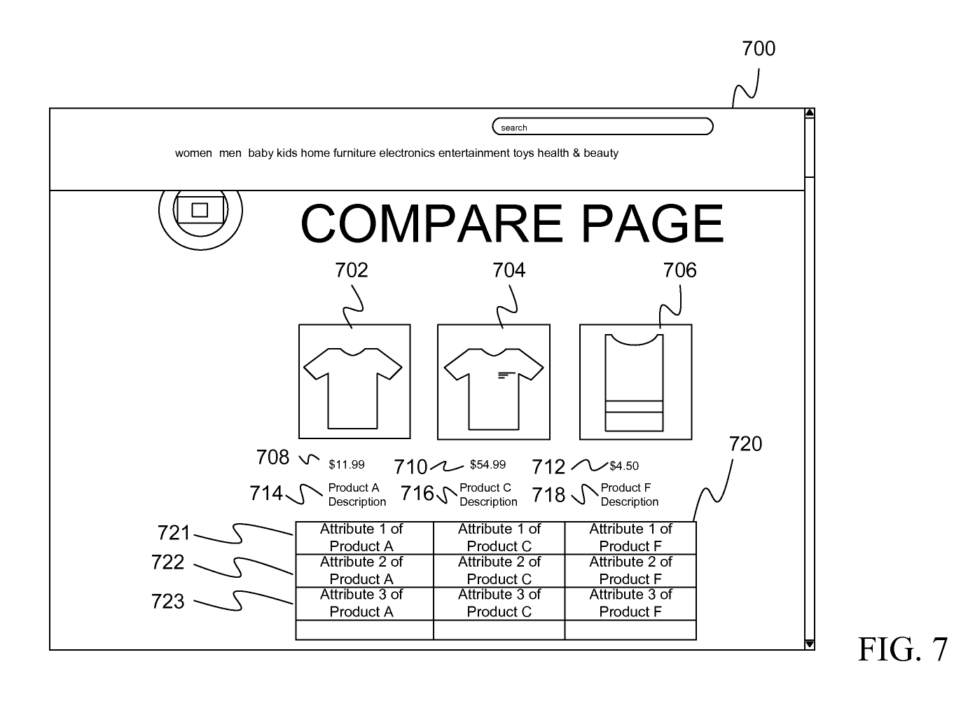

If “compare now” button 604 is selected in step 324 or “compare now” button 414 is selected in step 314, a compare page is displayed at step 328. If “compare now” button 604 is selected in step 324, the product associated with the last or latest compare check box to be selected is not included in the compare page because before that compare check box was selected, the maximum number of check boxes had already been checked. An example of a compare page is shown in FIG. 7.

In FIG. 7, a view of a generated image 700 is provided which displays a compare page. Generated image 700 includes product images 702, 704 and 706, corresponding prices 708, 710 and 712 and corresponding product descriptions 714, 716 and 718. Product descriptions 714, 716 and 718 may include the name of the product and a brief description of the product. Below the product descriptions, a table or chart 720 of compared attributes is provided. The chart 720 is shown in FIG. 7 as having vertical and horizontal lines to segment the different attributes from each other. Those skilled in the art will recognize that such lines are not necessary and blank spaces may be provided between the various attributes to distinguish the attributes from each other. In other embodiments, shading is used in an alternating manner to differentiate attributes from each other. In row 721 of chart 720, an attribute 1 of products A, C and F are compared. For example, attribute 1 can be the size of the products with the size of product A, size of product C and the size of product F shown in row 721. In row 722, attribute 2 of products A, C and F are shown and in row 724, attribute 3 of products A, C and F are shown. For example, attribute 2 may be the warranties of the products with the length of the warranty listed in row 722 for product A, product C and product F. Any attribute of a particular product may be listed in comparison chart 720 including, without limitation, modes of operation, functionality, compatibility with other products, available colors, battery requirements, battery duration and so forth.

By automatically generating a dialog box when a user has selected the trigger number of items to be compared or attempts to select more than the maximum number of items to be compared, the present innovations makes it easier for users to choose to compare items since they do not have to scroll through the page to locate the compare button. Further, the dialog box helps to inform the user that there is maximum number of items that can be compared on the comparison page and thereby assists the user.

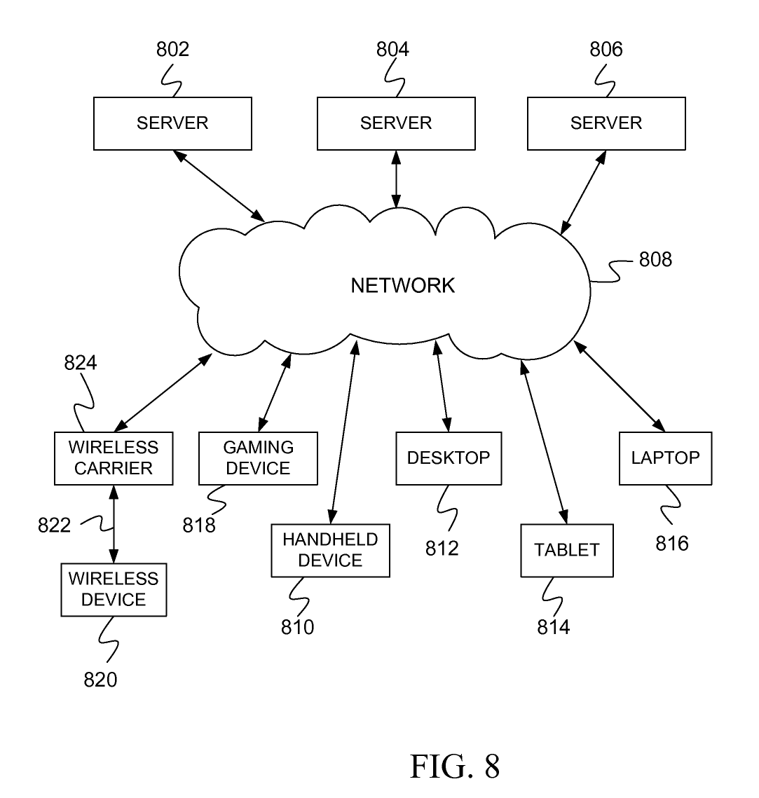

FIG. 8 provides a block diagram of a network environment which embodiments of the present invention may be practiced. In FIG. 8, a collection of servers 802, 804 and 806 store one or more webpages that can be requested by client devices through a network connection 808. Such network connections can include the Internet or other wide area networks or an intranet or other local area networks. Client devices can include, for example, handheld device 810, desktop 812, tablet 814, laptop 816, gaming device 818 or a wireless device 820. Wireless device 820, including such devices as cellular phones, can request webpages through a cellular connection 822 to a wireless carrier 824, which is connected to the network 808. The client devices listed for FIG. 8 are examples of available client devices and other client devices that are capable of connecting through a network 808 to one or more servers 802, 804 and 806 can be used with the present invention.

Communication along network 808 can utilize one or more protocols including Hypertext Transfer Protocol (http), Transmission Control Protocol/Internet Protocol (TCP/IP) and the like. The web pages provided by servers 802, 804 and 806 may be written in a mark-up language such as Hypertext Markup Language (HTML) or Extensible Markup Language (XML) and may utilize one or more Cascade Style Sheets. In addition, the web pages provided by servers 802, 804 and 806 may use one or more scripts for rendering the page including for example JavaScript®, from Oracle Corporation.

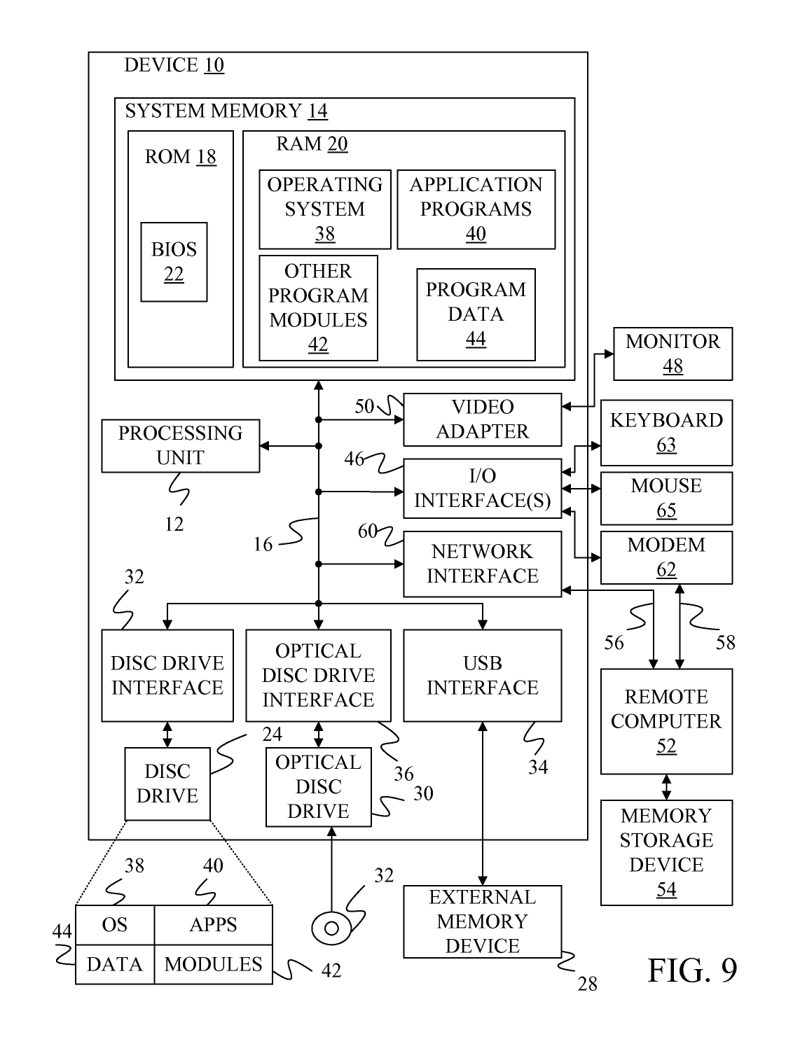

An example of a computing device that can be used as a server and/or client device in the various embodiments is shown in the block diagram of FIG. 9. The computing device 10 of FIG. 9 includes a processing unit or processor 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include server instructions that handle requests for web pages from a client, retrieve the content of the web pages and serve the web pages to the client when the computing device is used as a server. When the computing device is used as a client, application programs 40 can include a web browser that receives, interprets and renders one or more of the web pages described above. Such web browsers include script interpreters that are able to interpret script code in the web pages including script code that performs the steps of FIG. 3. The combination of the web browser and any script code in the web page can be considered computer-executable instructions that are stored on a computer-storage medium for execution by a processor. Program data 44 may include images and text that form one or more of the web pages including images of the product, images of one or more of the buttons, and the text in the containers that appear upon selecting the maximum number of items that can be compared. In addition, program data 44 can include the count of the number of items that are marked on the display as having been selected by the user for comparison.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 9. The network connections depicted in FIG. 9 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program, such as data stored in the databases or lists described above, may illustratively be stored within memory storage device 54. It will be appreciated that the network connections shown in FIG. 9 are exemplary and other means for establishing a communications link between the computers, such as a wireless interface communications link, may be used.

Processor/processing unit 12 may execute computer-executable instructions to perform the steps described above. In particular, the processor may retrieve the count of the number of checked items from memory and determine that the count is equal to the maximum number of items that can be compared. The processor may further display a dialog box comprising a link to a compare page in response to the count being equal to the maximum number of items that can be compared. The processor may further prevent marking more than the maximum number of items that can be compared as having been selected for comparison.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer storage medium having computer executable instructions that when executed by a processor cause the processor to perform steps comprising:
determining a count of products that have been marked on a display as being checked for comparison with each other; and
altering a display to add at least one compare link to the display in response to the count being equal to or greater than a trigger number, the compare link such that when the user selects the compare link, the display shows a comparison of the products that have been marked on the display.

2. The computer storage medium of claim 1 wherein altering the display to add at least one compare link to the display comprises altering the display without scrolling an image on the display.

3. The computer storage medium of claim 2 wherein altering the display to add at least one compare link comprises altering the display to add a dialog box over an image of selectable products, the dialog box comprising the compare link.

4. The computer storage medium of claim 3 wherein the dialog box further comprises a close icon that when selected removes the dialog box and the compare link from the display without showing a comparison of products.

5. The computer storage medium of claim 4 further comprising:
receiving an indication that a user wants to mark a latest selected product as being selected for comparison;
before marking the latest selected product on the display, determining if the count of the products that have been marked on the display as being selected for comparison with each other is equal to a maximum number of products that can be compared to each other; and
if the count does not equal the maximum number of products that can be compared with each other, altering the display so that the latest selected product is marked as being selected for comparison.

6. The computer storage medium of claim 5 further comprising:
if, before marking the selected product on the display, the count equals the maximum number of products that can be compared with each other, generating a display that does not mark the latest selected product as being selected for comparison.

7. The computer storage medium of claim 6 further comprising:
if, before marking the selected product on the display, the count equals the maximum number of products that can be compared with each other, adding a compare link such that when the user selects the compare link the display shows a comparison of products that does not include the latest selected product.

8. A computing system comprising:
a memory storing a count of the number of items that are marked on a display as having been selected by a user for comparison;
a processor retrieving the count from the memory and determining that the count is equal to or greater than a trigger number of items and displaying a dialog box comprising a link to a compare page in response to the count being equal to or greater than the trigger number of items.

9. The computing system of claim 8 wherein the compare page comprises a comparison of items marked on the display as having been selected for comparison.

10. The computing system of claim 9 wherein the trigger number of items is the same as a maximum number of items that can be compared.

11. The computing system of claim 10 wherein the processor prevents marking more than the maximum number of items that can be compared.

12. The computing system of claim 11 wherein before the processor retrieves the count:
the processor receives an indication that a user has selected a latest item;
the processor determines that the count is not equal to the maximum number of items that can be compared; and
the processor marks the latest item on the display as having been selected for comparison.

13. The computing system of claim 8 wherein the dialog box further comprises a close button that allows the dialog box to be dismissed without displaying the compare page.

14. The computing system of claim 8 wherein displaying the dialog box comprises displaying the dialog box over a display of selectable items such that at least one of the selectable items is obscured by the dialog box.

15. The computing system of claim 8 wherein the count is retrieved from memory in response to the user selecting an item to be marked for comparison.

16. A method comprising:
displaying a collection of items on a display;
receiving an input from a user indicating that an item in the collection of items should be marked for comparison; and
in response to the input, displaying an element comprising a link to a comparison page such that the element at least partially covers at least one of the items in the collection of items.

17. The method of claim 16 wherein displaying the element comprises only displaying the element if the number of items marked for comparison equals or exceeds a trigger number of items.

18. The method of claim 16 wherein displaying the element comprises displaying at least one icon that may be selected by the user to remove the element from the display without displaying the comparison page.

19. The method of claim 16 wherein the comparison page displays a comparison of the items marked for comparison.

20. The method of claim 16 wherein the element comprises a dialog box.
